(19) United States
(12) Patent Application Publication
(10) Pub. No.: US 2003/0041812 A1
(43) Pub. Date: Mar. 6, 2003

(54) Apparatus and method of manufacturing a cord

(76) Inventor: Chih-Cheng Lai, Taipei (TW)

Correspondence Address: OPPENHEIMER WOLFF & DONNELLY, P. O. BOX 10356, PALO ALTO, CA, 94303, US

(21) Appl. No.: 10/057,473

(22) Filed: Jan. 25, 2002

(30) Foreign Application Priority Data
Aug. 31, 2001 (CN) 01255497.9

(51) Int. Cl. A01K 27/00

(52) U.S. Cl. 119/795

(57) ABSTRACT

This invention discloses an apparatus and a method for manufacturing a dog leash. The dog leash has a plastic cover wrapped around the core along the axis of the leash. The plastic cover has at least two different color that can be divided evenly or in a different proportion. The color on the plastic cover can be formed in a straight line format or in a spiral shape.

### BACKGROUND OF THE INVENTION

1. Field of the Invention

The present invention relates generally to an apparatus and method of manufacturing a cord and more particularly to an apparatus and method of manufacturing a color dog leash or rope.

2. Description of the Prior Art

There are many different types of dog leash on the market. Some are designed for walking the dog, some others are designed to provide a proximity for the dog to move around from a tie down position in a public location such as a park or a playground. Dog leash designed for walking the dog usually are made from leather or from synthetic material such as polyester or nylon. However, leashes for keeping the dog within a proximity are usually made of steel wires covered with plastic. The steel wire is more durable and are less likely to be torn or break by dog chewing the leash. The steel wire is usually covered by monochrome plastic cover. Most of the dog leash are monochrome.

### SUMMARY OF THE INVENTION

It is an object of the present invention to provide a dog leash of multiple color.

It is another object of the present invention to provide a method of manufacturing a dog leash with multiple color on each cross-section of the leash.

Briefly, a presently preferred embodiment of the present invention includes a dog leash having a steel wire core having an axis; and a plastic cover wrapped around said steel core along the axis, wherein said plastic cover having at least two colors of different type in each cross section of said leash.

In an alternative embodiment, the present invention includes a dog leash having a core having an axis and a plastic cover wrapped around said core, wherein said plastic cover having at least two sections in each cross-section of said leash and each section having a color different from the other.

The present invention further includes a method of manufacturing a dog leash, including the steps of providing a longitudinal core; providing a mold having at least two openings and fitting said mold over said core in an orientation that is perpendicular to the axis of the core; feeding said core into an injection molding machine in a direction aligned with the axis of the core; and injecting plastics of different color into each opening.

An important advantage of the present invention is it provides a dog leash having multiple color cover.

It is another advantage of the present invention that it provides a method of manufacturing a dog leash with multiple color on each cross-section of the leash.

The foregoing and other objects, features, and advantages of the present invention will be apparent from the following detailed description of the preferred embodiment which makes reference to the several figures of the drawing.

### IN THE DRAWINGS

FIG. 1 is a diagram illustrating a longitudinal sectional view of a dog leash in accordance with the present invention;

FIG. 2A is a cross-sectional view of a dog leash having a three-color cover wrapped on the outside of a wire cord according to the present invention;

FIG. 2B is a cross-sectional view of a dog leash have a two-color cover wrapped on the outside of a wire cord in accordance with the present invention;

FIG. 3A is a diagram illustrating a mold used in an injection molding for manufacturing a three-color dog leash in accordance with the present invention; and

FIG. 3B is a diagram illustrating a mold used in an injection molding for manufacturing a two-color dog leash according to the present invention.

### DETAILED DESCRIPTION OF THE PREFERRED EMBODIMENTS

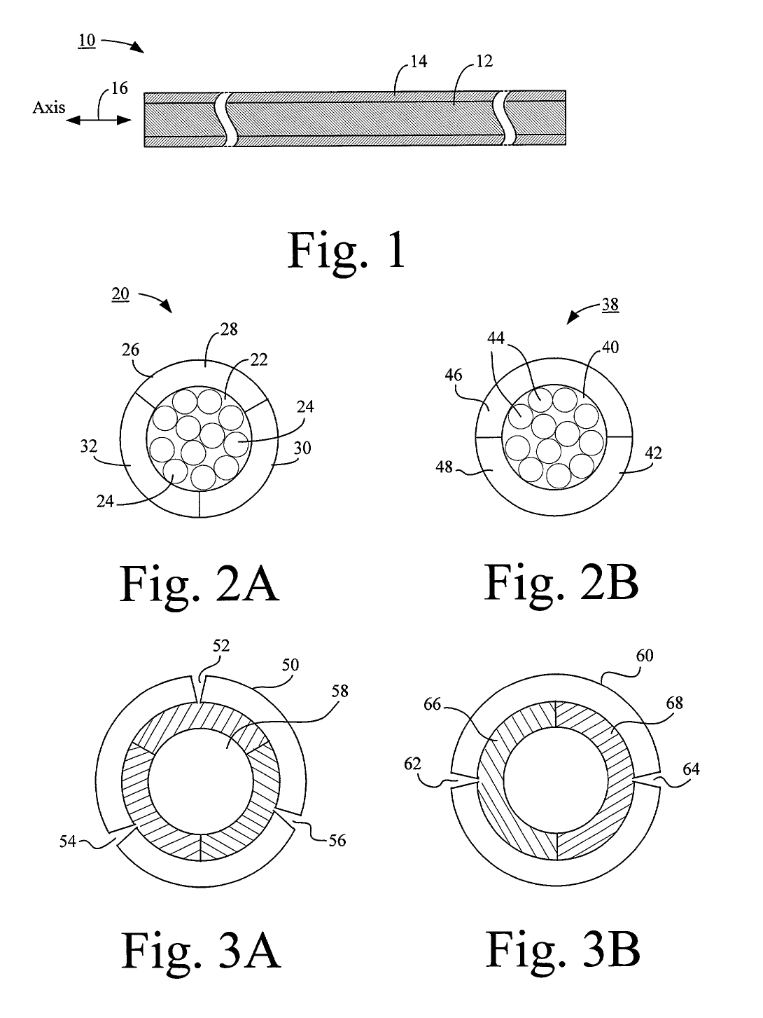

Referring to FIG. 1, which is a diagram illustrating a longitudinal sectional view of a art dog leash 10 in accordance with the present invention. The leash has a steel wire core 12 wrapped with a plastic cover 14. The core has an axis 16 parallel to the longitudinal orientation of the core. This type of dog leash is typically used to tie down the dog in a public area such as a park or playground. It is more durable because it has steel wire core. However, the plastic cover are all monochrome and has less ornamental value.

The present invention provides an apparatus and a method for manufacturing a multiple color dog leash 20. Referring to FIG. 2A, which is a cross-sectional view of a dog leash having a plastic cover. The plastic cover having three sections each having a color different from the other two wrapped on the outside of a wire cord according to the present invention. The multiple color dog leash 20 as illustrated in this example has a steel wire core 22 as described above. The core 22 could consist a plurality of steel wires 24 or a single solid steel wire (not shown). The outside plastic cover 26 has more than one color in each cross section of the leash. The plastic cover is wrapped around the core along the axis of the core. As illustrated in FIG. 2A, the plastic cover three colors 28, 30, 32.

Referring now to FIG. 2B, which is a cross-sectional view of a dog leash have a two-color cover wrapped on the outside of a wire cord in accordance with the present invention. As shown in FIG. 2B, the leash 38 also has a core 40 and a plastic cover 42. Similar to the leash shown in FIG. 2A, the core 40 could consist a plurality of steel wires 44 or a single solid steel wire. The plastic cover 42 has two colors 46, 48.

FIG. 3A is a diagram illustrating a mold used in an injection molding for manufacturing a three-color dog leash in accordance with the present invention. In the process of manufacturing a dog leash having a core 58 and a plastic cover 60. The plastic cover 5 is wrapped around the core through the process of plastic injection into a mold. In the present invention, plastic materials of different color is injected into a mold 50 having a plurality of openings 52, 54, 56. In this example, the mold 50 has three openings 52, 54, 56. The mold 50 fits over the steel wire core 58. The core 58 is fed into an injection molding machine having the mold 50 positioned over the core. The core 58 is fed into the injection molding machine in a steady speed in order to produce a leash of uniform size. Plastic cover of irregular shape will be produced if the core is fed in non-steady speeds. While the core is fed through the injection molding machine, plastics of different colors are injected into the three openings 52, 54, 56 respectively. Hence, forming a leash with multiple color plastic cover over the core.

FIG. 3B is a diagram illustrating a mold used in an injection molding for manufacturing a two-color dog leash according to the present invention. In this example, the mold 60 has two openings 62, 64 for manufacturing a leash with two colors 66, 68.

Although the two examples provided above seem to provide multiple color in even proportion. The mold 50 can be made to be positioned in an uneven spacing or with uneven sizes in openings. Hence, different volume of plastic can be injected into the mold for producing plastic cover in different color proportion. In an alternative embodiment, plastics of different color can be injected into the mold in different speed to provide different volume of plastics in different color. So that different color proportion can be produced for the plastic cover.

Alternatively, chambers for each color zone may be divided in an uneven proportion so that plastics with different color can be injected to cover different surface area of the core. As a result, different proportion of the plastic cover may also be produced.

In an alternative embodiment, the mold can be rotating along the axis 10 (FIG. 1) while the core is fed through the injection molding machine. Thus, plastic cover with spiral color can be produced to cover the core. In yet another alternative embodiment, the core can be rotating while it is being fed through the injection molding machine for the same effect to produce plastic cover with spiral color.

However, same color can be reused in alternating order if four or more openings are provided on the mold. Hence, a plastic cover of two alternating color can be produced. Three color may be used in such an arrangement if only one color is used to repeatedly and two other colors are used in alternating position.

The manufacturing operation can be summarized in following processes:

1. providing a mold of at least two openings over the core for producing plastic cover over a core on each cross section of the core;

2. feed the core into the injection molding machine along the axis of the core in a steady speed;

3. inject plastic of different colors into each opening;

4. adjust the volume of plastic input into each opening for dynamically changing the proportion of color distribution of the cover;

5. hold the mold steady for manufacturing straight color leash; or rotating the mold while feeding the core into the injection molding machine to product cover with spiral color along the axis of the core.

Although the present invention has been particularly shown and described above with reference to a specific embodiment, it is anticipated that alterations and modifications thereof will no doubt become apparent to those skilled in the art. It is therefore intended that the following claims be interpreted as covering all such alterations and modifications as fall within the true spirit and scope of the invention.

What is claimed is:

1. A dog leash, comprising:
a steel wire core having an axis; and
a plastic cover wrapped around said steel core along the axis, wherein said plastic cover having at least two colors of different type in each cross section of said leash.

2. A dog leash as recited in claim 1, wherein said plastic cover having three colors in each cross-section of said leash.

3. A dog leash as recited in claim 1, wherein said color formed in spiral shape along the axis of the core.

4. A dog leash as recited in claim 1, wherein said colors are distributed in even proportion.

5. A dog leash as recited in claim 1, wherein said colors are distributed in uneven proportion.

6. A dog leash as recited in claim 1, wherein said steel wire core includes a plurality of steel wires.

7. A dog leash, comprising:
a core having an axis; and
a plastic cover wrapped around said core, wherein said plastic cover having at least two sections in each cross-section of said leash and each section having a color different from the other.

8. A dog leash as recited in claim 7, wherein said plastic cover having three sections in each cross-section of said leash each section having a color different from the color in the other two sections.

9. A dog leash as recited in claim 7, wherein said color formed in spiral shape along the axis of the core.

10. A dog leash as recited in claim 7, wherein said colors are distributed in even proportion.

11. A dog leash as recited in claim 7, wherein said colors are distributed in uneven proportion.

12. A dog leash as recited in claim 7, wherein said steel wire core includes a plurality of steel wires.

13. A method of manufacturing a dog leash, comprising:
providing a longitudinal core;
providing a mold having at least two openings and fitting said mold over said core in an orientation that is perpendicular to the axis of the core;
feeding said core into an injection molding machine in a direction aligned with the axis of the core; and
injecting plastics of different color into each opening.

14. A method of manufacturing a dog leash as recited in claim 13, wherein the core is fed in a steady speed into the injection molding machine.

15. A method of manufacturing a dog leash as recited in claim 13, further comprising:
rotating said mold while feeding said core into the injection molding machine.

16. A method of manufacturing a dog leash as recited in claim 13, wherein said mold having three openings for manufacturing a leash with three color plastic cover.

17. A method of manufacturing a dog leash as recited in claim 13, wherein said mold having four openings for manufacturing a leash with a plastic cover having at least three colors.

18. A method of manufacturing a dog leash as recited in claim 17, comprising injecting plastic of same color into two non-adjacent openings.

19. A method of manufacturing a dog leash as recited in claim 13, wherein plastics of different color are injected into each opening.
